(19) United States
(12) Patent Application Publication
(10) Pub. No.: US 2006/0074164 A1
(43) Pub. Date: Apr. 6, 2006

(54) Structured composite dielectrics

(75) Inventors: Kirk M. Slenes, Albuquerque, NM (US); Dale Perry, Albuquerque, NM (US); Christopher Labanowski, Albuquerque, NM (US); Hope Perry, Albuquerque, NM (US); Erik Luther, Albuquerque, NM (US)

Correspondence Address: PEACOCK MYERS, P.C., 201 THIRD STREET, N.W., SUITE 1340, ALBUQUERQUE, NM, 87102, US

(73) Assignee: TPL, Inc., Albuquerque, NM (US)

(21) Appl. No.: 11/142,515

(22) Filed: May 31, 2005

Related U.S. Application Data
(63) Continuation-in-part of application No. 11/019,810, filed on Dec. 20, 2004.
(60) Provisional application No. 60/576,383, filed on Jun. 1, 2004.
(60) Provisional application No. 60/531,432, filed on Dec. 19, 2003.

(51) Int. Cl. C08K 3/22

(52) U.S. Cl. 524/413

(57) ABSTRACT

The present invention provides a structured, nano-composite, dielectric film. The invention also provides a method for producing the thin composite film. The composite material comprises ceramic dielectric particles, preferably nano-sized particles, and a thermoset polymer system. The composite material exhibits a high energy density.

### CROSS-REFERENCE TO RELATED APPLICATIONS

This application is a continuation-in-part application of U.S. patent application Ser. No. 11/019,810, entitled “Moldable High Dielectric Constant Nano-Composites”, filed Dec. 20, 2004, which claims priority to U.S. Provisional Patent Application Ser. No. 60/531,432, entitled “Moldable High Dielectric Constant Nano-Composites”, filed Dec. 19, 2003, and the specification and claims of those applications are incorporated herein by reference. This application also claims the benefit of the filing of U.S. Provisional Patent Application Ser. No. 60/576,383, entitled “Structured Composite Dielectrics”, filed Jun. 1, 2004, and the specification of that application is incorporated herein by reference. This application also is related to U.S. Pat. No. 6,608,760, entitled “Dielectric Material Including Particulate Filler” and U.S. Pat. No. 6,616,794, entitled “Integral Capacitance for Printed Circuit Board Using Dielectric Nanopowders”, and the specifications and claims of those applications are incorporated herein by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract Nos. N00178-03-C-3044 and N00178-04-C-1013 awarded by the U.S. Navy.

### BACKGROUND OF THE INVENTION

1. Field of the Invention (Technical Field)

The present invention relates to a process for producing structured composite dielectric films using nano-size particles.

2. Background Art

Structured dielectric composites that typically exhibit dielectric constants of less than 10 are known in the art. However, structures comprising films or exhibiting higher dielectric constants are not known. There is a need for improving the dielectric constants of structured dielectric composites and for structuring those composites in the form of thin films for use in capacitors.

### BRIEF SUMMARY OF THE INVENTION

The present invention comprises a structured dielectric film comprising at least one thermoset polymer system and at least one particle filler comprising ceramic particles. The composite preferably comprises a concentration of the particles of from between approximately 0 percent by weight and 90 percent by weight, more preferably of from between approximately 40 percent by weight and 65 percent by weight, and most preferably of from between approximately 50 percent by weight and 60 percent by weight.

The composite of preferably comprises an energy density of greater than approximately 6 joules/cc, and more preferably of greater than approximately 12 joules/cc.

The composite of the present invention preferably comprises ceramic particles which preferably comprise barium titanate, and more preferably barium strontium titanate. The thermoset polymer system preferably comprises a liquid epoxy polymer. The composite preferably comprises siloxane. The ceramic particles preferably comprise nano-size particles, more preferably a size of between approximately 10 nm and 1 μm, more preferably still of between approximately 50 nm and 500 nm, and most preferably of between approximately 100 nm and 300 nm. The composite of the present invention is solvent-free.

The invention also comprises a structured high dielectric constant film comprising the composite of the present invention. The composite of the structure is preferably aligned, and preferably in an arrangement consistent with the application of an alternating high voltage current to said composite.

The invention also comprises a method for fabricating a film structure comprising a high dielectric constant composite, the method comprising combining at least one thermoset polymer system and at least one particle filler comprising ceramic particles, the composite comprising a concentration of said particles of from between approximately 0 percent by weight and 90 percent by weight, more preferably of from between approximately 40 percent by weight and 65 percent by weight, and most preferably of from between approximately 50 percent by weight and 60 percent by weight. In the method, the composite comprises an energy density of greater than approximately 6 joules/cc, and more preferably of greater than approximately 12 joules/cc.

In the method, the ceramic particles preferably comprise barium titanate, and more preferably barium strontium titanate. The thermoset polymer system of the method preferably comprises a liquid epoxy polymer. The composite preferably comprises siloxane. The ceramic particles of the method preferably comprise nano-size particles. The method preferably comprises applying an alternating high voltage current to the composite to align the ceramic particles in the composite.

The method preferably comprises ball milling the ceramic particles prior to mixing. The method preferably also comprises dispersing the ceramic particles in a solvent prior to mixing the ceramic particles with the thermoset polymer system and removing the solvent after addition of the thermoset polymer system.

The method preferably comprises coating the composite onto a releasable substrate and pulling the composite past a heat source. Coating the composite preferably comprises extruding the composite under pressure through a die head. The method preferably comprises applying an alternating high voltage current to the composite to align the ceramic particles in the composite. Applying an alternating high voltage current preferably comprises disposing a first electrical contact on a base of the releasable substrate, disposing a second electrode offset from a surface of the composite thus forming a gap, and applying the current across the gap.

A primary object of the present invention is to provide for composite dielectric materials in film form that exhibit a combination of a high dielectric constant and high dielectric strength to achieve high energy density capabilities.

A primary advantage of the present invention is that it provides for higher energy storage capability.

Other objects, advantages and novel features, and further scope of applicability of the present invention are set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a schematic for electrode configuration for producing particle alignment;

FIG. 2 is a diagram of film extrusion using slot die coating;

FIG. 3 is a diagram of an aligning fixture;

FIG. 4 is a diagram of an arrangement of an aligning fixture;

FIG. 5 is a schematic of a film caster for particle alignment;

FIG. 6 is a diagram of a discontinuous field from a patterned electrode; and

FIG. 7 is a diagram showing the resultant field from a web movement past a patterned electrode.

### DETAILED DESCRIPTION OF THE INVENTION

The present invention comprises the use of high dielectric constant composite materials to form structured composite dielectric films. The present invention also comprises methods for producing the structured composite dielectric films. This process includes processes for uniformly dispersing and aligning the nano-size dielectric particles in a polymer matrix and fabrication processes for producing structured composite films for use in capacitor development. The dielectric materials encompassed in the present invention comprise a unique set of processing and dielectric performance characteristics, and the materials are based on a combination of inorganic powders, dispersants, polymers, and cure agents to for a composite material.

The present invention produces the structured composite in a film form for use in capacitor construction. In the preferred embodiment, the invention uses the combination of a high dielectric constant and high dielectric strength to achieve materials with high energy density capabilities.

The composite materials comprise a combination of high dielectric constant and high dielectric strength to achieve materials with high energy storage density capabilities to make power applications more efficient. The energy density of the materials of the present invention are preferably greater than approximately 6 Joules/cc, more preferably greater than approx. 9 Joules/cc, and most preferably greater than approximately 12 Joules/cc. Thus, the invention provides for the production of structured composite materials which improve capacitor development and which exhibit higher energy storage capabilities.

Non-refractory ferroelectric particles are preferably utilized in the present invention. In the preferred embodiment, ceramic dielectric particles, preferably nano-size dielectric particles, are dispersed in a polymer matrix. These ceramic particles typically comprise non-refractory ferroelectric particles. The methods of the present invention providing for a higher loading of the particles in the polymer matrix and the use of nano-sized dielectric particles results in the increased performance of the composite material of the present invention.

Preferably, the ceramic powders utilized comprise barium titanate and more preferably barium strontium titanate. Examples of such powders are those synthesized using a proprietary (TPL, Inc.) low temperature hydrothermal process. Nano-size particles are preferred as they exhibit better voltage performance characteristics. These nano-size particles are uniform and produce less of an electrical disruption or reduced flaw size within the composite and demonstrate greater retention of the polymer's intrinsic dielectric strength. The preferred sizes include, but are not limited to, those between approximately 10 nm and 1 μm, more preferably between approximately 50 nm and 500 nm, and more preferably still between approximately 100 nm and 300 nm. The preferred concentrations for the powders is from between approximately 0 wt. % and 90 wt. %, more preferably from between approximately 40 wt. % and 65 wt. %, and most preferably from between approximately 50 wt. % and 60 wt. %. The composite and method of the present invention wherein high particle loading is performed achieves such loading without negatively affecting the moldable characteristic of the composite of the present invention.

In an embodiment, the polymer comprises a thermosetting (thermoset) polymer system including, but not limited to, urethane, silicone, acrylic, and epoxy. Similar materials may be utilized. As the preferred polymer comprises a thermoset polymer, the composite material preferably also comprises a catalyst or cure agent. The final composite material preferably comprises no solvent, although a solvent is utilized in the preparation of the slurry. The preferable polymer and catalyst ratio is one that provides for a reasonable combination of working time and cure conditions.

In an embodiment of the present invention, the barium titanate (or similar material) slurries are preferably prepared by ball milling. Powder dispersions are preferably made first in a solvent (e.g., acetone) using a standard milling process. The solvent provides for better dispersion and higher loading of the particles. Preferably, a first portion of the polymer is added to the dispersion toward the end of the milling process, preferably during the final four hours of milling. Following milling, the second portion of the polymer (i.e., the cure agent) is added.

The solvent is then preferably removed from the slurry so that the final composite is solvent-free. Removal of the solvent is preferred because its presence in the final material impedes the properties sought for, and the structure of, the final structured composite. Removal is preferably done by rotary evaporation, and preferably under the application of vacuum and heat. The preferred heat utilized is based on the boiling point of the solvent utilized and removal continues until the solvent is removed (e.g., when it is observed that boiling has stopped). Other methods or steps for slurry preparation known in the art may be utilized. Other nano-size particles of different compositions and made by different processes may also be used in the invention.

In an embodiment, a siloxane with a titanate loading is utilized. The amount of titanate loading, the amount of the functional group on the siloxane, the epoxy to siloxane ratio, and the cure time determine the best peel and flexibility and higher voltage capability. Preferably, an approximately 55% by weight siloxane having a functional group level of 35% by weight is utilized with a titanate loading of 65% by weight. The functional group on the siloxane is amine-epoxy chemistry for crosslinking which provides for film structures. The concentration of the functional group dictates the rate of film formation and the physical properties of the final film. Voltage capability increases slightly with an increase in the amount of siloxane and decreases with an increase in cure time.

In an embodiment, a process herein referred to as “aging” is performed in the preparation of the composite slurry. The aging process comprises a controlled reaction initiation of the thermoset resin system and allows for minimal polymerization between the epoxy and the siloxane without polymerization in three dimensions so that an increase in molecular weight and viscosity results. Thus, the invention comprises a process for improved composite wetting and the elimination of coating defects. Preferably, the aging process takes place at approximately room temperature for between approximately 48 and approximately 96 hours.

In an embodiment, particles are aligned in the composite to enhance dielectric properties. Preferably, alternating high voltage current can be applied to the composite resin prior to polymer cure to induce particle movement into desired structures. An example includes applying approximately 1.0 kHz to a 50 percent by weight barium titanate/epoxy composite during the cure process to induce chaining of the particles in the polymer matrix. The particles orient in the polymer to form a 1-3 composite structure (particle chaining parallel to the electric field). This results in a significant increase in dielectric constant. Oriented composites prepared in accordance with the present invention have shown a dielectric constant of, for example, 12.8 versus 6.8 for the non-oriented composites.

Alignment of the particles in the composite material is preferably performed using a power source with high voltage and high frequency such as, for example, a high voltage alternating current power amplifier. The available frequency control allows for use of a signal specific to the material under evaluation. Higher voltage allows for the generation of higher electric fields which increases the rate of fibril formation. Effective particle alignment has been demonstrated over a range of applied electric fields. While rate of alignment is dependent on the magnitude of the applied electric field, particle alignment in less than a few seconds is preferred with an applied electric field between 0.1 V/μm and 10 V/μm. Finally, the higher electric fields increase fibril length with particle continuity forming between electrodes, as opposed to partial fiber formation propagating from the electrodes.

Higher titanate concentrations provide for a significant increase in dielectric constant without significantly impacting the voltage performance. For example, an 80 percent by weight composite (0-3 structure) allows for a dielectric constant of 30 which is an order of magnitude increase in dielectric constant over the base polymer. If the relative improvement in dielectric constant in the 1-3 composite created as a result of particle alignment is possible in the 80 wt % composite with a minor loss in dielectric strength, an energy density of over 10 Joules/cc is possible.

To incorporate the film of the present invention in a capacitor, a film roll stock form is required in order to be compatible with conventional film winding and capacitor manufacturing. Thus, the alignment configuration is made to allow for film production capabilities.

The production of the film is affected by the manner in which the electric field is applied across the curing composite film. A non-contact method for applying the field conserves the quality of the coated film. Preferably, the first electrical contact is located on the base of the releasable substrate and carrier while the top electrode is offset from the surface of the coating and the electric field is applied across the resulting gap.

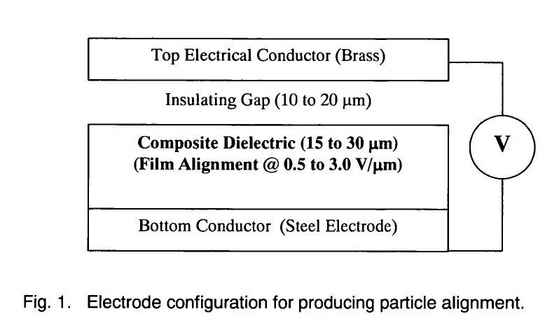

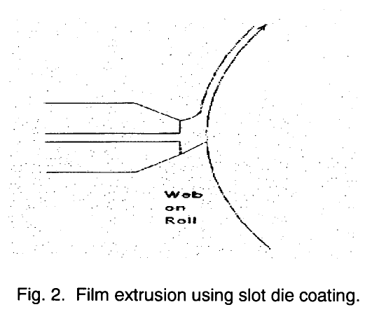

The general configuration involves coating the composite dielectric onto a conductive substrate and applying an offset electric field across the dielectric during the cure process. An alternative embodiment is used for continuous film production. A schematic of the electrode configuration for producing particle alignment is presented in FIG. 1. In an alternative embodiment, film extrusion is obtained using slot die coating (see FIG. 2).

The composite dielectrics of the present invention are useful as films in roll form produced in association with a releasable substrate, such as, but not limited to, an ultra-smooth siliconized mylar substrate, which is required for continuous film production. Higher alternating current voltage is required to achieve the same electric field across the composite.

In one embodiment, for alignment of particles in the composite dielectrics, a pilot coater is modified to allow for alignment of the nano-size powder during the continuous film production process. Deposition of the composite is performed by pressurized extrusion of the viscous slurry through a fixed gap on a precision die head. The coating is formed on a thin polymer carrier and pulled through a series of curing zones for particle alignment and polymerization. Following polymer cure, the film product is spooled onto a core that is compatible with the subsequent metallization process.

Critical casting parameters are established to produce a consistent film with the desired composite structure and polymer cure. Film thickness and uniformity are controlled through adjustment of the die gap, extrusion pressure, coat rate and controlling viscosity of the composite slurry using temperature. The coating process also requires balancing with respect to the necessary alignment conditions (voltage, frequency and time) and polymer cure conditions (time and temperature) during the continuous coating process. This process provides for the fabrication of rolls (e.g. 8″ rolls) for conversion into a capacitor film.

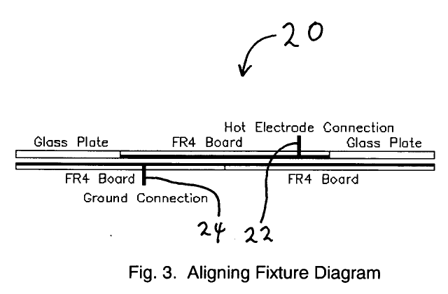

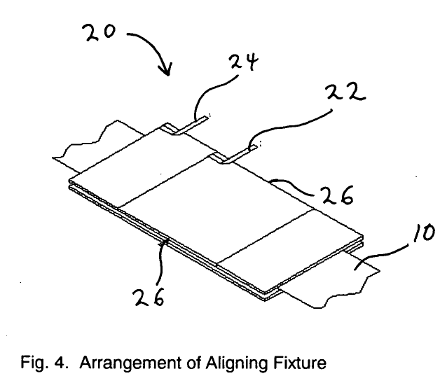

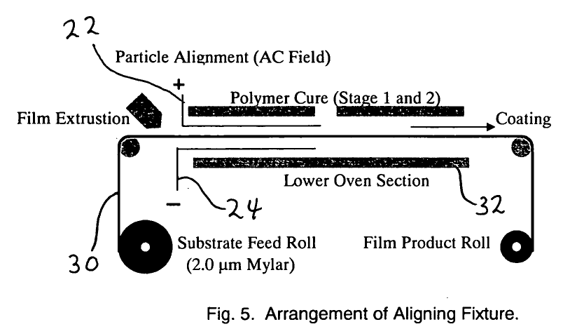

As noted above, the production of the film is affected by the manner in which the electric field is applied across the curing composite film. In an embodiment, alignment fixture 20, shown in FIGS. 3 and 4, is preferably utilized as shown in FIG. 5 to apply an alternating current voltage to the composite coating on the film carrier. Preferably, a first electrical contact 24 is located on the base of the releasable substrate and carrier while the top electrode 22 is offset from the surface of the coating, and the electric field is applied across the resulting gap. The composite slurry is coated on the releasable substrate 30 (shown in FIG. 5), preferably an ultra-smooth siliconized Mylar substrate, to form web-borne dielectric 10 and pulled through the parallel electrode configuration past a heat source 32, preferably the oven section of a coater. The thermal set polymer is cured as the particles are aligned. The basic, parallel plate, electrode design used for the alignment fixture can be easily modified to tailor the field conditions.

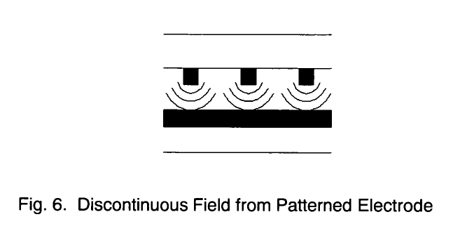

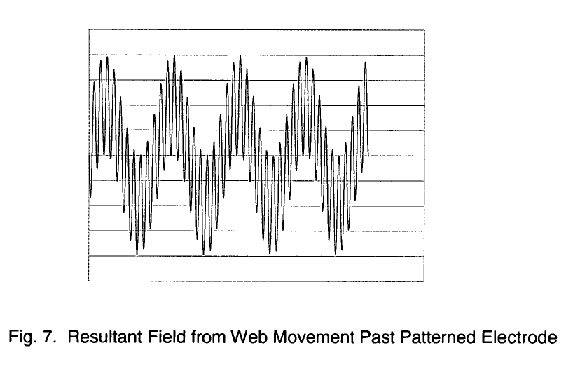

The benefits of the electric field can be enhanced through the use of patterned electrodes. Such electrode patterning creates a secondary field oscillation resulting from the movement of the web-borne dielectric past repeating fields as shown in FIG. 6. The secondary field oscillation is superimposed on the primary filed oscillation that is caused by the high voltage power supply, alternating current field. Thus, there is a higher-frequency sine wave superimposed on a lower-frequency sine wave (web movement past electrodes, shown in FIG. 7) that may enhance movement in the dielectric material to achieve a greater degree of alignment.

An SF6 gas may be introduced into the alignment fixture at points 26 (shown in FIG. 5) to improve field strength.

Thus, the present invention provides for the production of structured composite dielectric films with capacitor function to be sandwiched between electrodes. The present invention provides for dielectric constants of greater than 60. A structured composite dielectric film possessing a high dielectric constant has application in electrical insulation and capacitors, and in continuous capacitor film fabrication. The present invention provides for films comprising a thickness of less than approximately 10 μm.

The performance benefits of particle alignment in the nano-composite structures include a significant increase in energy storage capability through the addition and alignment of the nano-size titanate powders. The preferred embodiment of the present invention provides for a significant performance enhancement in the 50 wt. % composite.

Performance data supports a potential for a significant advancement in dielectric energy density capabilities. Measured properties on the 1-3 structured nano-composite (50 weight %) material supports over a 400% increase in dielectric constant over the base polymer.

### Industrial Applicability

The invention is further illustrated by the following non-limiting examples.

### EXAMPLE

Optical Microscopy Evaluations

Barium titanate/epoxy slurries were evaluated using optical microscopy to identify alignment characteristics in the electric field. The dilute slurries were poured onto glass slides prepared with electrodes. The electrodes were made by wrapping insulated magnet wire around the glass slide and gluing the ends in place. The separation distance between the magnet wire was made as small as possible, approximately 1 mm. The insulation was stripped from the ends of the wire to allow electrical contact. A Variac and a step-up transformer were used to apply an electric field across the electrodes. The Variac and the transformer allowed for up to 400 V at a fixed frequency of 60 Hz. Because the separation distance was typically 1 mm, a field stress up to 4.0 V/μm field was applied.

A power amplifier was used in combination with an AC signal generator to provide the sinusoidal, low voltage signal for amplification at frequencies up to 40 kHz and at a voltage of 2.0 kV ms. A five minute epoxy was used to create a ‘trough’ for the slurry to spread and the microscope light was used sparingly to allow the alignment of the barium titanate particles in the applied electric field within several minutes.

Electrical Stress Evaluations (60 Hz and Low Voltage)

The relationship between the dielectric loss at 60 Hz and capability for particle alignment was confirmed by evaluations of slurries prepared with over 20 polymers and two insulating oils. First, all polymers, a silicone oil and castor oil were characterized to establish the dielectric loss as a function of frequency. The slurries were then characterized in the microscope fixture under an electric field to determine the alignment characteristics. Polymers with a high dielectric loss (>30%) demonstrated little to no particle alignment while the remaining polymers with moderate dielectric loss (≈10%) resulted in fiber formation at the surface of the wire.

Particles formed on the surface of the composite slurry when the electric field was applied across an insulating air gap. When the electric field was turned off, the particles drifted off into the slurry via Brownian motion within 15 seconds of removing the field. It was assumed that the slurry-air interface disrupted the frequency characteristics, e.g., higher harmonics led to particle alignment. Higher electric fields demonstrated increased fibril length with particle continuity forming between electrodes, as opposed to partial fiber formation propagating from the electrodes.

Particulate fibrils were formed 700 Hz and a field stress of approximately 8.0 V/μm in less than one minute. The particle alignment showed clear formation of fibers under stress.

Electrical Stress Evaluations (Higher Frequency and Voltage)

Higher frequency and higher voltage capabilities were acquired after establishing the relationship between dielectric loss and alignment capability. Because the dielectric loss of the polymers was reduced at higher frequency, there is capability for improved particle alignment.

The frequency control was used to determine a signal specific to the material under evaluation. Particle behavior was investigated for the frequency range from 10 Hz to 10 kHz. Second, the higher voltage capabilities were used to generate higher electric fields which increased the rate of fibril formation.

Microscope evaluations of the fibril formation at 500× were used to refine the optimum alignment conditions. Continuity of fiber formation and rate of fiber formation were evaluated throughout the available frequency range and applied field stress. Results from the microscope evaluations are included in Table 1.

TABLE 1
Alignment Behavior/Fibril Formation as a
Function of Frequency and Voltage Stress

| | Applied Field Stress on Composite | | |
|---|---|---|---|
| Frequency | <1.0 V/μm | 1.0-3.0 V/μm | 3.0-8.0 V/μm |
| <100 Hz | Very slow | swirling movement | edge fibers/ |
| | movement | | swirling |
| 100-600 Hz | no movement | edge fibers/ | edge fibers/ |
| | | movement | swirling |
| 600 Hz-1.0 kHz | edge fibers | long edge fibers | continuous |
| | | | fibers |
| 1.0-10 kHz | no movement | no movement | no movement |

Results from the microscope evaluations showed the composites alignment conditions to depend significantly on frequency and field stress. An optimum frequency of 700 Hz was defined for the composite system. Fiber formation was rapid (<5 seconds) with continuous fibers forming between electrodes at high stress, 3.0 to 8.0 V/μm.

Dielectric Properties

A significant increase in energy storage capability was demonstrated with the addition and alignment of the nano-size titanate powders. Composite films were prepared, alignment was introduced, polymer was cured and dielectric constant was measured. The results demonstrate a significant performance enhancement in the 50 percent by weight composite.

A 110% improvement in dielectric constant was observed through the titanate addition in a 1-3 composite structure. This improvement was further enhanced through structuring of the composite. The 1-3 composite film prepared uses 700 Hz and a field stress of 4.3 V/μm demonstrated a 425% increase in dielectric constant. Structuring of the particles increases the benefit of the titanate addition by a factor of three.

| | Dielectric Constant |
|---|---|
| Base Polymer | 3.3 |
| Base Polymer + 50 wt. % BaTiO₃ | 6.3 |
| Base Polymer + 50 wt. % BaTiO₃ (aligned) | 12.8 |

The preceding examples are repeated with similar success by substituting the generically or specifically described reactants and/or operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A structured composite dielectric film comprising at least one thermoset polymer system and at least one particle filler comprising ceramic particles, wherein said composite comprises a concentration of said particles of from between approximately 0 percent by weight and 90 percent by weight.

2. The composite of claim 1 comprising a concentration of said particles of from between approximately 40 percent by weight and 65 percent by weight.

3. The composite of claim 2 comprising a concentration of said particles of from between approximately 50 percent by weight and 60 percent by weight.

4. The composite of claim 1 wherein said composite comprises an energy density of greater than approximately 6 joules/cc.

5. The composite of claim 4 comprising an energy density of greater than approximately 12 joules/cc.

6. The composite of claim 1 wherein said ceramic particles comprise barium titanate.

7. The material of claim 6 wherein said ceramic particles comprise barium strontium titanate.

8. The composite of claim 1 wherein said thermoset polymer system comprises a liquid epoxy polymer.

9. The composite of claim 1 further comprising siloxane.

10. The composite of claim 1 wherein said ceramic particles comprise nano-size particles.

11. The composite of claim 10 wherein said ceramic particles comprise a size of between approximately 10 nm and 1 μm.

12. The composite of claim 11 wherein said ceramic particles comprise a size of between approximately 50 nm and 500 nm.

13. The composite of claim 12 wherein said ceramic particles comprise a size of between approximately 100 nm and 300 nm.

14. The composite of claim 1 being solvent-free.

15. A film structure comprising a high dielectric constant composite, said composite comprising at least one thermoset polymer system and at least one particle filler comprising ceramic particles, said composite comprising a concentration of said particles of from between approximately 35 percent by weight and 70 percent by weight.

16. The structure of claim 13 wherein said composite comprises a concentration of said particles of from between approximately 0 percent by weight and 90 percent by weight.

17. The structure of claim 16 wherein said composite comprises a concentration of said particles of from between approximately 40 percent by weight and 65 percent by weight.

18. The structure of claim 15 wherein said composite comprises an energy density of greater than approximately 6 joules/cc.

19. The structure of claim 18 wherein said composite comprises an energy density of greater than approximately 12 joules/cc.

20. The structure of claim 15 wherein said ceramic particles comprise barium titanate.

21. The structure of claim 20 wherein said ceramic particles comprise barium strontium titanate.

22. The structure of claim 15 wherein said thermoset polymer system comprises a liquid epoxy polymer.

23. The composite of claim 14 further comprising siloxane.

24. The structure of claim 15 wherein said ceramic particles comprise nano-size particles.

25. The structure of claim 24 wherein said wherein said ceramic particles comprise a size of between approximately 10 nm and 1 μm.

26. The structure of claim 25 wherein said wherein said ceramic particles comprise a size of between approximately 50 nm and 500 nm.

27. The structure of claim 26 wherein said wherein said ceramic particles comprise a size of between approximately 100 nm and 300 nm.

28. The structure of claim 15 wherein said composite is solvent-free.

29. The structure of claim 15 wherein said ceramic particles are aligned in said composite.

30. The structure of claim 18 wherein said ceramic particles are aligned in said composite in an arrangement consistent with the application of an alternating high voltage current to said composite.

31. A method for fabricating a film structure comprising a high dielectric constant composite, the method comprising combining at least one thermoset polymer system and at least one particle filler comprising ceramic particles, the composite comprising a concentration of said particles of from between approximately 0 percent by weight and 90 percent by weight.

32. The method of claim 31 wherein the composite comprises a concentration of said particles of from between approximately 40 percent by weight and 65 percent by weight.

33. The method of claim 32 wherein the composite comprises a concentration of said particles of from between approximately 50 percent by weight and 60 percent by weight.

34. The method of claim 31 wherein the composite comprises an energy density of greater than approximately 6 joules/cc.

35. The method of claim 34 wherein the composite comprises an energy density of greater than approximately 12 joules/cc.

36. The method of claim 31 wherein the ceramic particles comprise barium titanate.

37. The method of claim 36 wherein the ceramic particles comprise barium strontium titanate.

38. The method of claim 31 wherein the thermoset polymer system comprises a liquid epoxy polymer.

39. The method of claim 31 wherein the ceramic particles comprise nano-size particles.

40. The composite of claim 31 further comprising siloxane.

41. The method of claim 31 further comprising the step of ball milling the ceramic particles prior to mixing.

42. The method of claim 31 further comprising the steps of:
dispersing the ceramic particles in a solvent prior to mixing the ceramic particles with the thermoset polymer system; and
removing the solvent after addition of the thermoset polymer system.

43. The method of claim 31 further comprising coating the composite onto a releasable substrate and pulling the composite past a heat source.

44. The method of claim 43 wherein coating the composite comprises extruding the composite under pressure through a die head.

44. The method of claim 43 further comprising applying an alternating high voltage current to the composite to align the ceramic particles in the composite.

44. The method of claim 44 wherein applying an alternating high voltage current comprises:
disposing a first electrical contact on a base of the releasable substrate;
disposing a second electrode offset from a surface of the composite thus forming a gap;
and applying the current across the gap.
